(19) United States
(12) Patent Application Publication
(10) Pub. No.: US 2010/0329537 A1
(43) Pub. Date: Dec. 30, 2010

(54) COMPUTER-IMPLEMENTED METHODS OF IDENTIFYING AN OPTICAL CHARACTER RECOGNITION (OCR) FONT TO ASSIST AN OPERATOR IN SETTING UP A BANK REMITTANCE COUPON APPLICATION

(76) Inventor: Michael E. Gardi, Waterloo (CA)

Correspondence Address: PAUL W. MARTIN, NCR CORPORATION, LAW DEPT., 3097 SATELLITE BLVD., 2nd FLOOR, DULUTH, GA, 30096, US

(21) Appl. No.: 12/491,771

(22) Filed: Jun. 25, 2009

(51) Int. Cl. G06K 9/00

(52) U.S. Cl. 382/140; 382/218

(57) ABSTRACT

A computer-implemented method is provided of identifying an optical character recognition (OCR) font to assist an operator in setting up a bank remittance coupon application. The computer-implemented method comprises electronically on a processor reading an OCR font in a zone of the bank remittance coupon, electronically on a processor comparing the read OCR font with an OCR font stored in a look-up table to determine if the read OCR font meets predetermined criteria, and storing the read OCR font into a configuration file to setup at least a portion of the bank remittance coupon application when the read OCR font meets the predetermined criteria.

### BACKGROUND

The present invention relates to bank remittance coupons, and is particularly directed to computer-implemented methods of identifying an optical character recognition (OCR) font to assist an operator in setting up a bank remittance coupon application.

In known processes for setting up bank remittance coupon applications, a human operator manually keys in required information including OCR font information into a number of configuration files. The OCR fonts used in a typical bank remittance coupon application are usually alphanumeric text-based fonts. Differences between some of the OCR fonts are minute. These minute differences sometime make it difficult for an operator to distinguish between different OCR fonts.

If an operator should happen to incorrectly identify an OCR font, then the bank remittance coupon application will not function, and time will be needed to troubleshoot and correctly identify the OCR font. It would be desirable to provide the operator with assistance to correctly identify an OCR font from the beginning so that such troubleshooting time is avoided.

### SUMMARY

In accordance with one embodiment of the present invention, a computer-implemented method is provided of identifying an optical character recognition (OCR) font to assist an operator in setting up a bank remittance coupon application. The computer-implemented method comprises electronically on a processor reading an OCR font in a zone of the bank remittance coupon, electronically on a processor comparing the read OCR font with an OCR font stored in a look-up table to determine if the read OCR font meets predetermined criteria, and storing the read OCR font into a configuration file to setup at least a portion of the bank remittance coupon application when the read OCR font meets the predetermined criteria.

### BRIEF DESCRIPTION OF THE DRAWINGS

In the accompanying drawings:

FIG. 1 is a diagram of a typical known bank remittance coupon;

FIG. 2 is a diagram of a number of known optical character recognition (OCR) fonts which can appear in various zones of the bank remittance coupon of FIG. 1;

FIG. 3 is a flowchart depicting a known method of setting up a bank remittance coupon application; and

FIG. 4 is a flowchart depicting a computer-implemented method of setting up a bank remittance coupon application in accordance with one embodiment of the present invention.

### DETAILED DESCRIPTION

The present invention relates to bank remittance coupons, and is particularly directed to computer-implemented methods of identifying an optical character recognition (OCR) font to assist an operator in setting up a bank remittance coupon application.

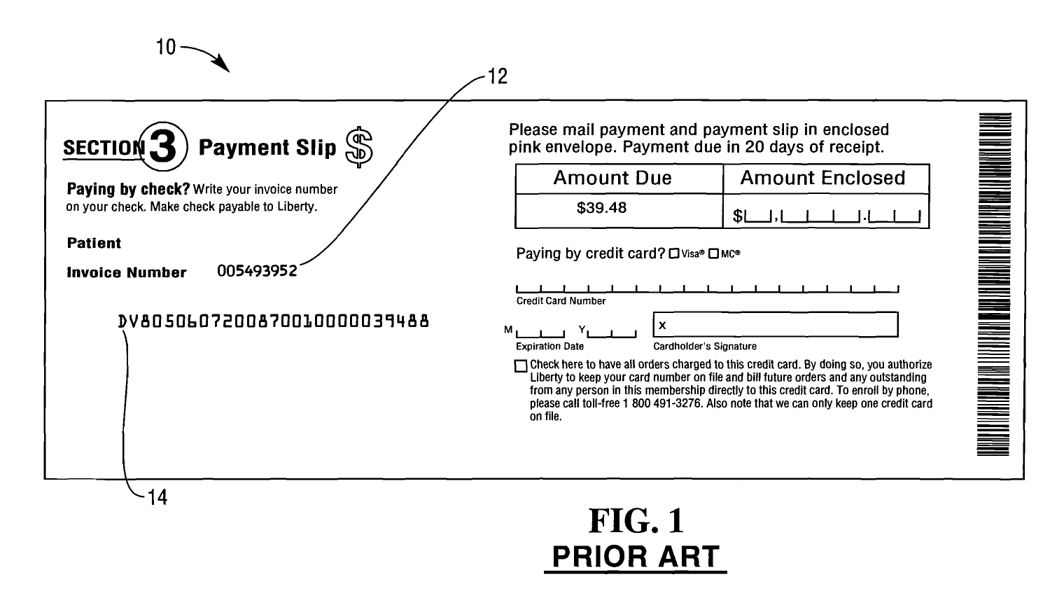

An example of a bank remittance coupon is illustrated in FIG. 1, and is designated with reference numeral “10”. Coupon 10 comprises a number of different zones and a number of fields contained in each zone. Two fields shown in FIG. 1 include an invoice number field 12 and an account number field 14 which is associated with a payor of the coupon 10.

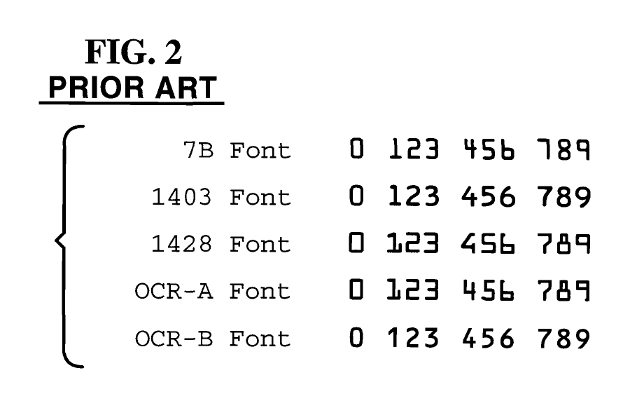

As shown in the example coupon of FIG. 1, the invoice number field 12 contains numeric only text of a first font type, and the account number field 14 contains alphanumeric text of a second font type which is different from the first font type. More specifically, the first font type is “1403 font”, and the second font type is “OCR-A font”. These two font types, as well as three other example font types, are shown in FIG. 2 to illustrate differences between different font types. The other three font types shown in FIG. 2 are “7B font”, “1428 font”, and “OCR-B font”. As can be seen in FIG. 2, differences between some of the font types are minute.

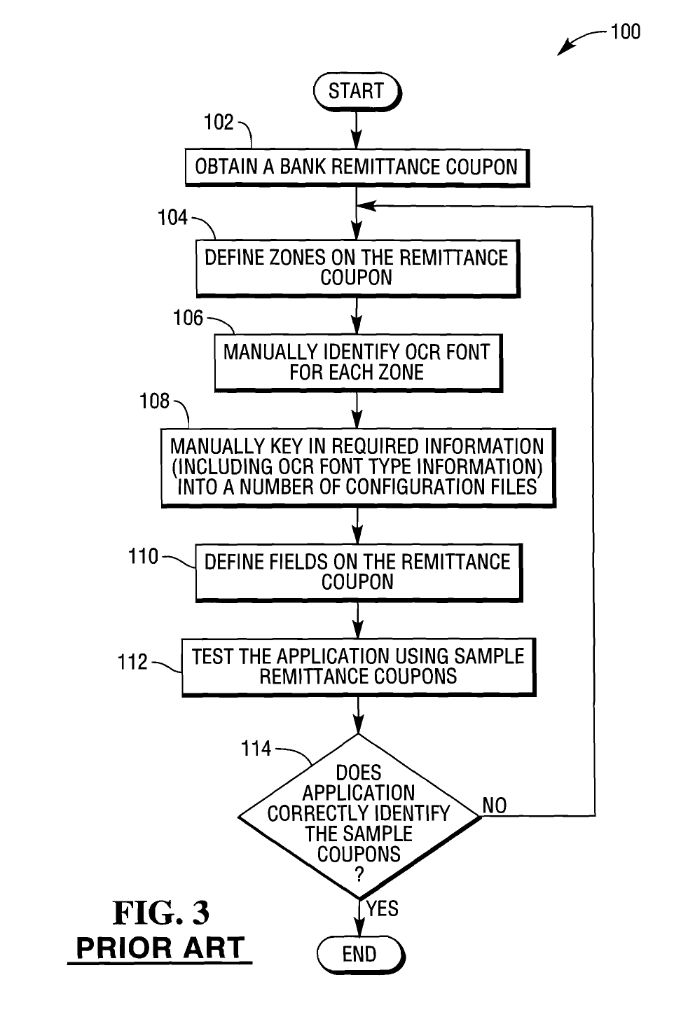

A known method of setting up a bank remittance coupon application is illustrated in flowchart 100 of FIG. 3. When a human operator receives a bank remittance coupon (step 102), such as the coupon 10 shown in FIG. 1, the operator defines zones on the coupon (step 104). The operator manually identifies the type of OCR font contained in each zone of the coupon (step 106).

The operator then manually keys in required information into a number of configuration files (step 108). The required information keyed in includes the OCR information identified back in step 106. The operator then manually defines fields on the coupon (step 110). The operator tests the bank remittance coupon application by OCR reading a number of sample remittance coupons (step 112).

A determination is made as to whether the bank remittance coupon application correctly identifies the sample remittance coupons which have been OCR read (step 114). If the determination in step 114 is affirmative (i.e., the remittance coupon application correctly identifies all of the sample coupons), then the process of setting up the application is complete and the process terminates. However, if the determination in step 114 is negative (i.e., the remittance coupon application does not correctly identify all sample coupons), then the process proceeds back to step 104 to allow the operator to redefine zones or fields, as needed, to try again and setup the bank remittance coupon application.

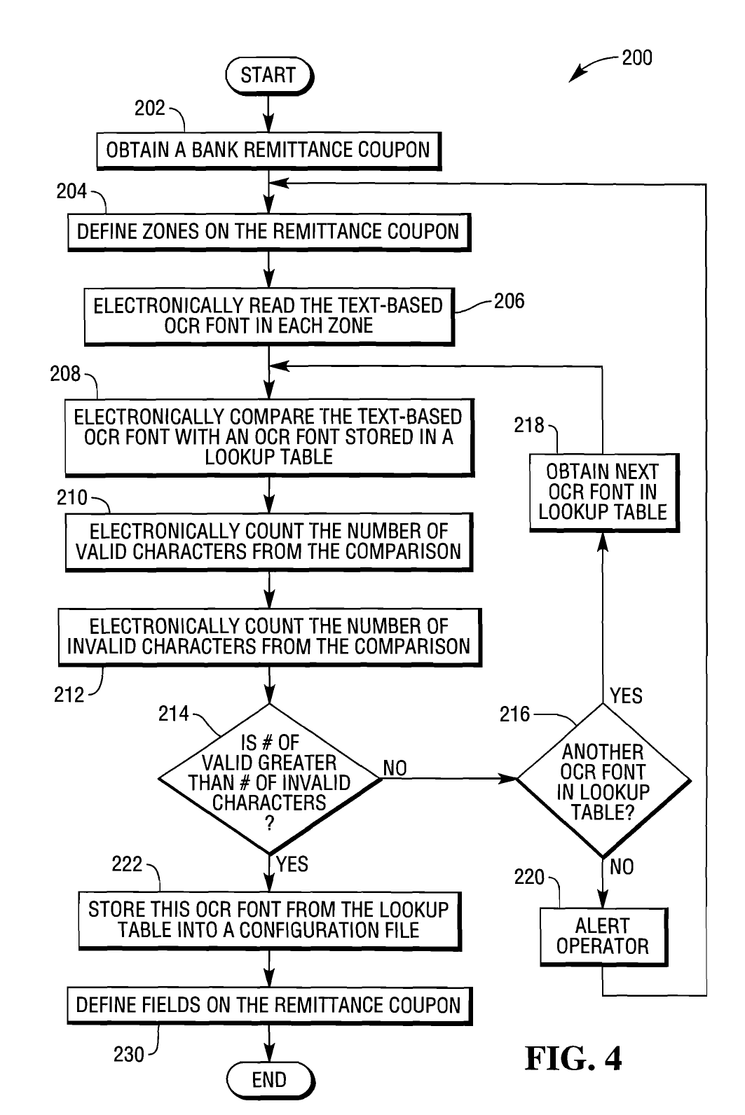

In accordance with one embodiment of the present invention, a computer-implemented method of setting up a bank remittance coupon application is illustrated in flowchart 200 of FIG. 4. When a human operator receives a bank remittance coupon (step 202), such as the coupon 10 shown in FIG. 1, the operator defines zones on the coupon (step 204). The operator then takes actions so that the type of OCR font contained in each defined zone can be correctly identified. These actions are described in steps described hereinbelow.

As shown in step 206, the operator takes action so that the alphanumeric text-based font contained in each defined zone is electronically read. Such actions taken by the operator may comprise the operator running a suitable electronic scanning device over each zone to allow the device to electronically read the OCR font contained in that particular zone. The electronic scanning device has an electronic processor for electronic processing OCR font data which has been scanned in. Suitable electronic processors, such as microcomputers, are well known, and therefore will not be described. After the OCR font is electronically read, the OCR font is electronically compared with an OCR font which is stored in a look-up table of the device (step 208).

Based upon the electronic comparison of step 208, the number of valid characters is electronically counted (step 210). Also, the number of invalid characters is electronically counted (step 212). A determination is then made in step 214 as to whether the counted number of valid characters is greater than the counted number of invalid characters.

If the determination in step 214 is affirmative (i.e., the number of valid characters is greater than the number of invalid characters), then the particular OCR font from the look-up table back in step 208 is stored into a configuration file (step 222). Accordingly, the OCR font contained in the particular zone of the coupon has been identified and stored in the configuration file. The operator then manually defines fields on the coupon (step 230) to complete the process of setting up the bank remittance coupon application.

However, if the determination in step 214 is negative (i.e., the number of valid characters is not greater than the number of invalid characters), then the process proceeds to step 216 in which a determination is made as to whether there is another OCR font contained in the look-up table. If the determination in step 216 is affirmative (i.e., there is another OCR font contained in the look-up table), then the next OCR font contained in the look-up table is obtained (step 218). The process returns back to step 208 so that the electronically-read OCR font back from step 206 can be compared with this new OCR font from the look-up table.

However, if the determination in step 216 is negative (i.e., there is no other OCR font contained in the look-up table), then the process proceeds to step 220 in which the operator is alerted that there was no “match” between the electronically-read OCR font from step 206 and an OCR font from the look-up table. At this point, the operator may attempt to manually identify the OCR font contained in this particular zone of the bank remittance coupon.

It should be apparent that an OCR font from a particular zone of a bank remittance coupon is compared with a number of OCR fonts from a look-up table, and then subsequently stored into a configuration file. More specifically, after the OCR font from the particular zone has been electronically read, the OCR font is automatically detected and stored into a configuration file, without any human intervention. This method of auto detection of an OCR font contained in a zone of a bank remittance coupon allows a person without any knowledge about minute differences between different OCR fonts to setup a bank remittance coupon application. Accordingly, even a person not familiar with differences between different OCR fonts can easily setup a bank remittance coupon application. The result is time savings and cost savings in the form of primarily labor cost savings.

It should also be apparent that the read OCR font is in a configuration file when the comparison of the read OCR font meets predetermined criteria. In this example, the predetermined criteria are that the number of valid characters from the read OCR font exceeds the number of invalid characters from the read OCR font. It is conceivable that other predetermined criteria may be used.

Further, it should be apparent that the OCR fonts stored in the look-up table are reference OCR fonts against which the read OCR font can be compared. It is conceivable that these reference fonts may be stored in a manner other than a look-up table.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A computer-implemented method of identifying an optical character recognition (OCR) font to assist an operator in setting up a bank remittance coupon application, the computer-implemented method comprising:
electronically on a processor reading an OCR font in a zone of the bank remittance coupon;
electronically on a processor comparing the read OCR font with an OCR font stored in a look-up table to determine if the read OCR font meets predetermined criteria; and
storing the read OCR font into a configuration file to setup at least a portion of the bank remittance coupon application when the read OCR font meets the predetermined criteria.

2. A computer-method according to claim 1, wherein comparing comprises (i) comparing a number of valid characters between the read OCR font and the OCR font stored in the look-up table, and (ii) comparing a number of invalid characters between the OCR font and the OCR font stored in the look-up table.

3. A computer-method according to claim 2, wherein the predetermined criteria comprises the number of valid characters being greater than the number of invalid characters.

4. A computer-implemented method of identifying an optical character recognition (OCR) font to assist an operator in setting up a bank remittance coupon application, the computer-implemented method comprising:
electronically on a processor reading an OCR font in a zone of the bank remittance coupon;
electronically on a processor comparing the read OCR font with at least one reference OCR font to determine if at least a certain number of characters from the read OCR font are valid characters; and
storing the read OCR font into a configuration file to setup at least a portion of the bank remittance coupon application when at least a certain number of characters from the read OCR font are determined to be valid characters.

5. A computer-method according to claim 4, further comprising electronically on a processor determining a number of invalid characters from the read OCR font.

6. A computer-method according to claim 5, wherein comparing comprises determining if the number of characters from the read OCR font is greater than the number of invalid characters from the read OCR font.

7. A computer-method according to claim 4, wherein the at least one OCR font is stored in a look-up table of an electronic scanning device.
